(19) United States
(12) Patent Application Publication
(10) Pub. No.: US 2013/0330386 A1
(43) Pub. Date: Dec. 12, 2013

(54) STRUCTURE, SYNTHESIS, AND APPLICATIONS FOR CONJUGATED POLYAMPHOLYTES

(71) Applicants: David G. Whitten, Albuquerque, NM (US); Kirk Schanze, Gainesville, FL (US); Eunkyung Ji, Albuquerque, NM (US); Thomas S. Corbitt, Albuquerque, NM (US); Dimitri Dascier, Albuquerque, NM (US)

(72) Inventors: David G. Whitten, Albuquerque, NM (US); Kirk Schanze, Gainesville, FL (US); Eunkyung Ji, Albuquerque, NM (US); Thomas S. Corbitt, Albuquerque, NM (US); Dimitri Dascier, Albuquerque, NM (US)

(21) Appl. No.: 13/993,026

(22) PCT Filed: Dec. 12, 2011
(86) PCT No.: PCT/US2011/064460

§ 371 Date: Aug. 29, 2013

Related U.S. Application Data
(60) Provisional application No. 61/422,130, filed on Dec. 11, 2010.

(51) Int. Cl. A01N 41/04

(52) U.S. Cl. CPC A01N 41/04
USPC 424/409; 528/172; 424/78.37

(57) ABSTRACT

The present disclosure provides novel polyampholyte compounds, methods for synthesizing these compounds, and materials and substances incorporating these compounds. The various polyampholytes show antibacterial activity and may also demonstrate antiviral antifungal and/or antibiofilm activity.

### CROSS-REFERENCE TO RELATED APPLICATIONS

The following application claims benefit of U.S. Provisional Application No. 61/422,130, which is hereby incorporated by reference in its entirety.

### STATEMENT REGARDING GOVERNMENT SPONSORED RESEARCH

This invention was made with Government support under grant number W911NF-07-0079 awarded by the Defense Threat Reduction Agency. The U.S. Government has certain rights in this invention.

### BACKGROUND

Polymers containing ionic groups can be divided into two groups: polyelectrolytes and polyampholytes. The former possess either anionic or cationic groups along the polymer chains, while the latter contain both anionic and cationic groups on different monomer units within the polymer chain. Over the past decade, there has been increasing interest in conjugated polyelectrolytes (CPEs), which are water soluble polymers featuring ionic functional groups on a conjugated backbone such as poly(paraphenylene) (PPP), poly(phenylene vinylene) (PPV) or poly(phenylene ethynylene) (PPE). The ionic charged groups give CPEs water solubility as well as the ability to interact with oppositely charged ionic species, yet they retain the intrinsic electronic and optical properties characteristic of π-conjugated polymers. Because of the unique properties of CPEs, they have been considered as useful materials for chemo- and biosensor applications. See e.g., Pinto et al. Synthesis-Stuttgart 2002, 1293; Liu et al., J. Photochem. Photobio., C 2009, 10, 173; Chen et al., Proc. Nast. Acad. Sci. U.S.A. 1999, 96, 12289; Pinto et al., Proc. Natl. Acad. Sci. U.S.A. 2004, 101, 7505; and Thomas et al., Chem. Rev. 2007, 107, 7505. Additionally, CPEs are amphiphilic due to the presence of both ionic groups and hydrocarbon content and therefore they are capable of self-assembly into aggregates in solution, resulting in changes of photophysical behavior of the polymer in solution. See e.g., Tan et al., Chem. Commun 2002, 446; and Tan et al., Adv. Mater. 2004, 16, 1208. The propensity of the polymer chains to aggregate also enhances the amplified quenching response (as indicated by the Stern-Volmer quenching constant, K_{SV}) of CPEs by oppositely charged quencher ions. See, e.g., Tan et al., Chem. Commun 2002, 446; Tan et al., Adv. Mater. 2004, 16, 1208; and Zhao et al., Macromolecules 2006, 39, 6355.

Polyampholytes have been of interest, in part because they are synthetic analogs for proteins. Therefore they can contribute to understanding the aqueous solution behavior of biological molecules such as proteins and be applied to various areas of biotechnology, medicine, and hydrometallurgy. See e.g., McCormick et al., Polymeric Materials Encylopedia; CRC Press: Boca Raton, 1996, Vol. 7, p 5462 and Ibraeva et al., Chem Phys. 2004, 205, 2464. However, to date there have not been any reports concerning the synthesis or properties of conjugated polyampholytes. Properties of polyampholytes in solution are controlled by Coulombic attraction between anionic and cationic groups on different monomer units. Polyampholytes exhibit both polyelectrolyte and anti-polyelectrolyte behavior depending on the chemical structure and the composition of the polymer, the absence/addition of other electrolytes and solution pH.

Polyampholytes can be categorized into four general classes on the basis of their pH response. First, type I polyampholytes are composed of strong cationic (i.e., quaternary alkyl ammonium groups) and strong anionic groups (i.e., sulfonate groups) which remain fully ionized over the entire range of pH. Type II polyampholytes feature strong cationic and weak anionic groups (e.g., carboxylate groups), the latter of which can be neutralized at low pH. Type III polyampholytes, contain weak cationic groups (e.g., amine hydrohalides) that can be neutralized at high pH, combined with strong anionic groups that remain charged over the whole range of pH. Finally a type IV polyampholyte contains both weak anionic and weak cationic groups which are both responsive to changes in pH. Type I polyampholytes retain their zwitterionic charge character over a wide range of pH, whereas the other classes will undergo transitions concomitant with pH induced charge neutralization of the weak cation or anion units.

### SUMMARY

The present disclosure provides novel polyampholyte compounds, methods for synthesizing these compounds, and materials incorporating these compounds. According to an embodiment, the polyampholytes of the present disclosure have the base structure shown in FIG. 1 where k is selected from the numbers between 5 and 200 and X and Y are either single aromatic rings or a pair of aromatic rings, where X and Y are either both single aromatic rings or both a pair of aromatic rings. In embodiments where X is a single aromatic ring, the aromatic ring has the same negatively charged chain at the C-3 and C-6 positions. In embodiments where X is a pair of aromatic rings, one of the aromatic rings has the same negatively charged chain at the C-3 and C-6 positions and the other aromatic ring has the same neutrally charged carbon chain at the C-3 and C-6 positions. Furthermore, in the embodiment where Y is a single aromatic ring, the aromatic ring has the same positively charged chain at the C-3 and C-6 positions. In embodiments where Y is a pair of aromatic rings, one of the aromatic rings has the same positively charged chain at the C-3 and C-6 positions and the other aromatic ring has the same neutrally charged carbon chain at the C-3 and C-6 positions.

### BRIEF DESCRIPTION OF THE DRAWINGS

FIG. 1 depicts the basic structure of an exemplary polyampholyte according to the present disclosure.

FIG. 2 depicts more specific version of the polyampholyte of FIG. 1 wherein the polyampholyte comprises a single aromatic ring at each base position.

FIG. 3 depicts more specific version of the polyampholyte of FIG. 1 wherein the polyampholyte comprises a pair of aromatic rings at each base position.

FIG. 4 shows the chemical structure of another exemplary polyampholyte of the present disclosure which is referred to herein as PPE-NMe₃⁺-SO₃⁻.

FIG. 5 depicts an exemplary synthesis scheme for PPE-NMe₃⁺-SO₃⁻.

FIG. 6 depicts the chemical structure of additional exemplary polyampholytes of the present disclosure which are referred to herein as PPE-SO₃⁻—OR8-NMe₃⁺-1 and PPE-SO₃⁻—OR8-NMe₃⁺-2.

FIG. 7 depicts an exemplary synthesis scheme for PPE-SO₃⁻—OR8-NMe₃⁺-1 and PPE-SO₃⁻—OR8-NMe₃⁺-2.

FIG. 8 depicts the chemical structure of another exemplary polyampholyte of the present disclosure which is referred to herein as PPE-NMe₃⁺-COO⁻

FIG. 9 depicts an exemplary synthesis scheme for PPE-NMe₃⁺-COO⁻

FIG. 10 depicts the results of a biocidal activity study of PPE-NMe₃⁺-COO⁻

FIG. 11 depicts the results of a biocidal activity study of the PPE-SO₃⁻—OR8-NMe₃⁺ series.

FIG. 12 is a graph of the absorption spectra of PPE-NMe₃⁺-COO⁻ (c=30.7 μM) as a function of pH in aqueous solution. (The inset is the legend for both FIGS. 5 and 6.

FIG. 13 is a graph of the fluorescence (b) (γ=440 nm) spectra of PPE-NMe₃⁺-COO⁻ (c=30.7 μM) as a function of pH in aqueous solution. The inset illustrates that fluorescence intensity at 548 nm varies depending on the pH in the polymer solution.

FIG. 14 is a graph of the absorption and fluorescence spectra of PPE-NMe₃⁺-COO⁻ in methanol and aqueous solution. The fluorescence spectra are normalized according to relative fluorescence quantum yields.

FIG. 15 provides the structure of NDS.

FIG. 16 is Stern-Volmer plots (γₑₓ=440 nm and γₑₘ=548 nm) for PPE-NMe₃⁺-COO⁻ (c=30.7 μM) quenching by an anionic quencher, NDS at different pH solutions.

FIG. 17 is a graph of the emission spectra (γₑₓ=440 nm) of the mixture of PPE-NMe₃⁺-COO⁻ (c=30.7 μM) and NDS (c=30 μM) depending on pH.

FIG. 18 is a graph of hydrodynamic radii obtained from dynamic light scattering for PPE-NMe3+-COO— (5 μM) at different pH solutions.

FIG. 19 is a graphic demonstrating the relationship between the fluorescence quenching efficiency of the conjugated polyampholyte solution and solution pH.

### DETAILED DESCRIPTION

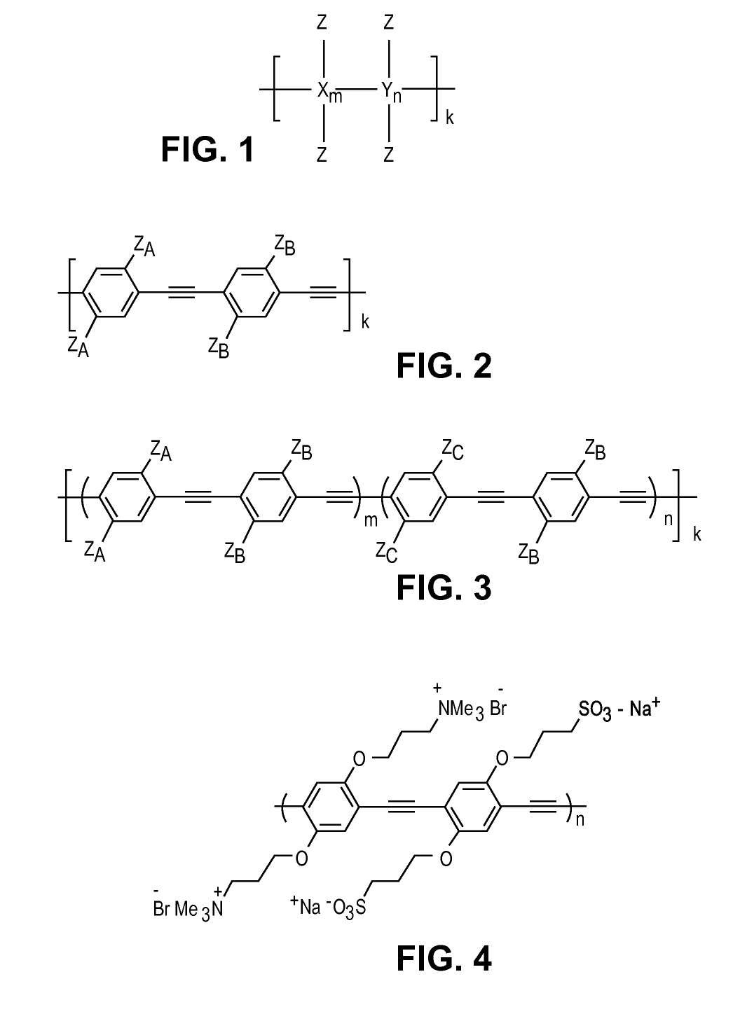

The present disclosure provides a plurality of novel compounds generally referred to herein as polyampholytes, methods of synthesizing the polyampholytes described herein and various uses for the disclosed polyampholytes. According to an embodiment, the present disclosure provides polyampholytes having the general structure shown in FIG. 1, where k is selected from the numbers between 5 and 200. According to various embodiments of the disclosure, X is either a single aromatic ring (A in FIG. 2) or a pair of aromatic rings (A-A in FIG. 3). It will be noted that as shown in the depicted embodiments, the aromatic rings may be phenyl rings. If X is a single aromatic ring, the aromatic ring has the same negatively charged functional group at the C-3 and C-6 positions; and if X is a pair of aromatic rings, one of the aromatic rings has the same negatively charged functional group at the C-3 and C-6 positions and the other aromatic ring has the same neutrally carbon chain at the C-3 and C-6 positions. Similarly, Y is either a single aromatic ring (FIG. 2) or a pair of aromatic rings (FIG. 3), wherein if Y is a single aromatic ring, the aromatic ring has the same positively charged functional group at the C-3 and C-6 positions; and if X is a pair of aromatic rings, one of the aromatic rings has the same positively charged functional group at the C-3 and C-6 positions and the other aromatic ring has the same neutrally charged carbon chain at the C-3 and C-6 positions.

According to more specific embodiments of the present disclosure, the negatively charged functional group are selected from O(CH₂)₃SO₃⁻ and OCH₂COO⁻; the positively charged functional group are selected from O(CH₂)₃N(CH₃)₃⁺ and O(CH₂)₃(C₆H₁₂N₂)C₆H₁₃²⁺; and the neutrally charged carbon chain is O(C₂H₄O)₂CH₃.

The polyampholytes disclosed herein can exist in solution, in colloidal suspensions, and attached, for example, to surfaces by various covalent linkages. All of the polyampholytes disclosed herein are fluorescent and demonstrate biocidal activity. Furthermore, some or all of the compounds may demonstrate viricidal, fungicidal, and/or anti-biofilm activity as well.

FIG. 4 shows the chemical structure of another exemplary embodiment of a polyampholyte structure of the present disclosure which is referred to herein as PPE-NMe₃⁺-SO₃⁻. PPE-NMe₃⁺-SO₃⁻ is a type I polyampholyte that combines sulfonate RSO₃⁻ and quaternary ammonium RNME₃⁺ pendants along the polymer backbone. In general, this polyampholyte is poorly soluble in a variety of solvents, which is typical of type I polyampholytes that contain quaternary ammonium and sulfonate ionic units in even charge ratio.

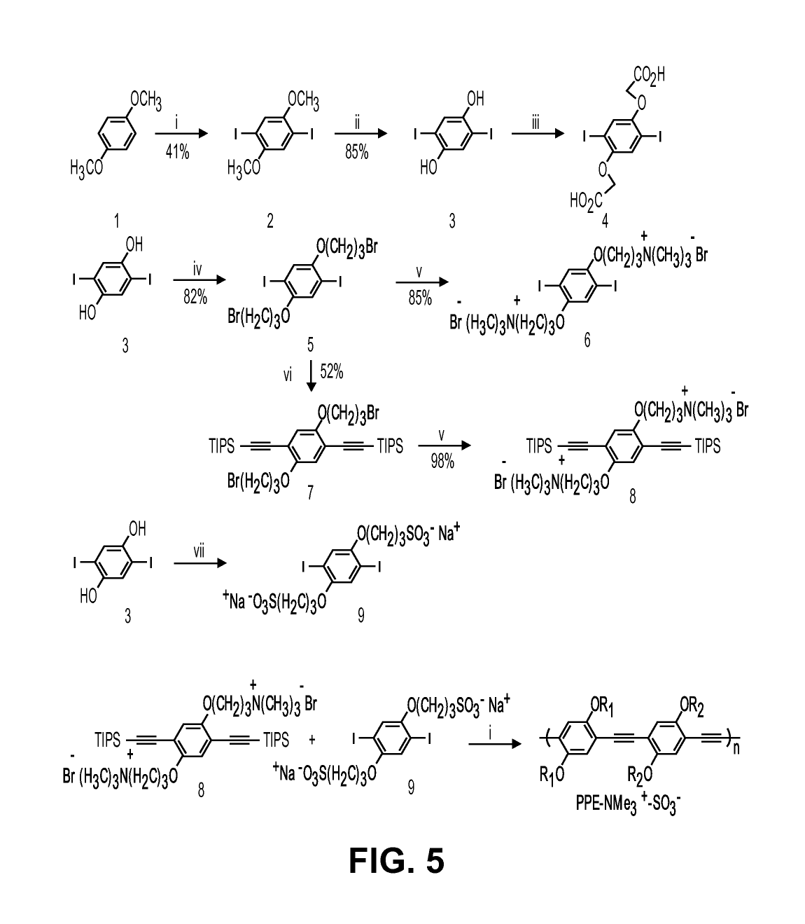

An exemplary synthesis scheme for PPE-NMe₃⁺-SO₃⁻ is shown in FIG. 5. Briefly, 1,4-Bis(triisopropylsilylethynyl)-2,5-Bis(3-bromopropoxy)aromatic (compound 7) was synthesized as follows: Under an argon atmosphere, THF (20 mL) and diisopropylamine (2.5 mL) were added to compound 5 (98 mg, 1.56 mmol), Pd(PPh₃)₂Cl₂ (62 mg, 0.09 mmol) and CuI (45 mg, 0.234 mmol).The mixture solution was degassed by argon bubbling at room temperature for 20 minutes and this was followed by the dropwise addition of trisopropylsilylacetylene (0.63 mL, 2.77 mmol). The solution was stirred at room temperature for 40 hours. The solvent was removed and the solid was purified by flash chromatography on silica gel with hexane to yield a white solid 7 (570 mg, 0.80 mmol 51%). 1H NMR (300 MHz, CDCl₃): δ 1.14 (s, 42H), 2.29 (m, 4H), 3.60 (t, 4H), 4.08 (t, 4H), 6.89 (s, 2H).

3,3′-(2,5-bis((Triisopropylsilyl)ethynyl)-1,4-phenylene)bis(oxy)bis(N,N,N-trimethylpropan-1-aminium) (compound 8) was synthesized as follows: Compound 7 (210 mg, 0.25 mmol) was suspended in 25% trimethylamine in water (20 mL), ethanol (30 mL), and acetone (30 mL) and heated to 120° C. The reaction was refluxed overnight. The solvent was removed and the white solid recrystallized from ethanol to yield 200 mg (0.24 mmol, 98%). 1H NMR (300 MHz, CDCl3): δ 1.10 (s, 42H), 2.23 (m, 4H), 3.12 (s, 18H), 3.48 (m, 4H), 4.08 (t, 3H), 6.99 (s, 2H).

The solvent mixture (17 mL) of DMF/H₂O/(iPr)₂NH (v/v/v/=9/6/2) was degassed with argon for 15 minutes and followed by the addition of compound 8 (100 mg, 0.12 mmol). After argon bubbling through the solution for 15 minutes, 1.0 M tetrabutylammonium fluoride solution in THF (1.60 mmol) was added to the flask under argon and the mixture was stirred at room temperature for 30 minutes. In a separate flask, a solution of CuI (4 mg, 0.02 mmol) and Pd(PPh₃)₄ (11 mg, 0.01 mmol) in DMF was degassed with argon for 30 minutes and added to the degassed solution containing compound 8. Addition of compound 9 and 15 minute degassing were followed. Finally the solution was stirred under argon atmosphere at 60° C. for 24 hours. The reaction mixture was poured into 200 mL of acetone. The precipitate was dissolved in small amount of Millipore water and treated with NaCN, filtered using 25 μm glass filter and followed by dialysis against deionizer water using 6-8 kD MWCO cellulose membrane. The polymer solution was lyophilized to yield a yellow solid (35 mg, 0.036 mmol, 30%). ¹H NMR (300 MHz, CD₃OD) and ¹³C NMR (75 MHz, CD₃OD) spectra were not obtained due to the poor solubility of the compound.

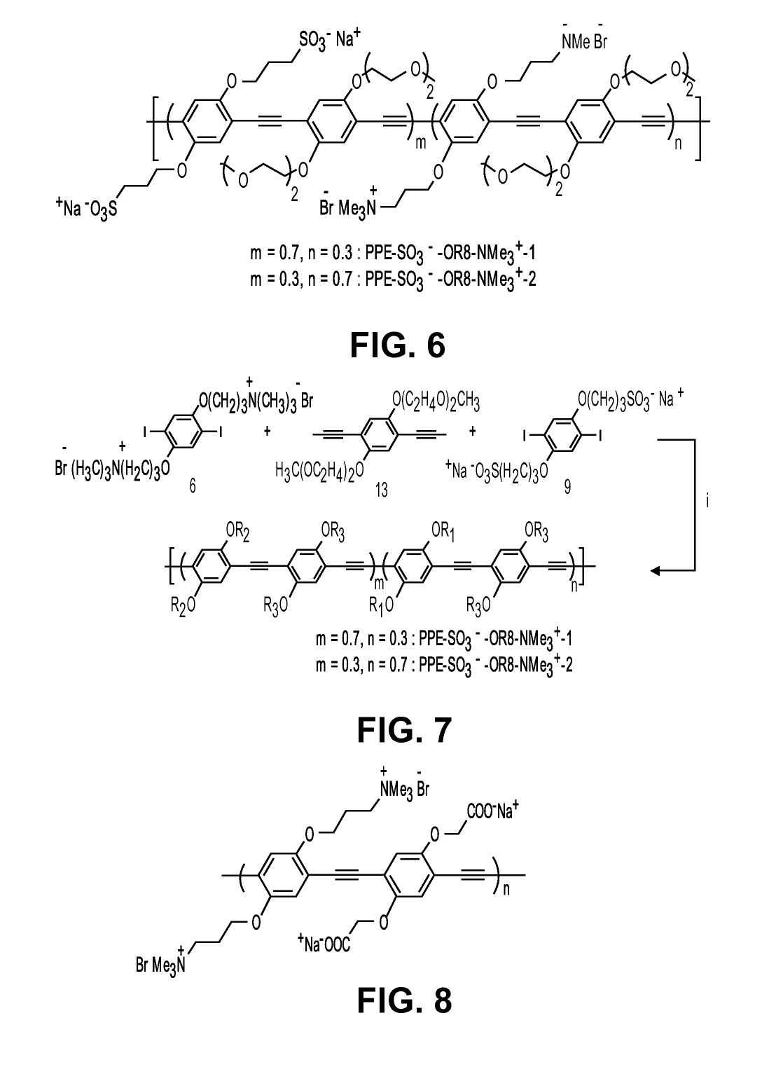

FIG. 6 shows the chemical structure of an exemplary embodiment of two polyampholyte structures of the present disclosure which are referred to herein as PPE-SO3⁻-OR8-NMe₃⁺-1 and PPE-SO₃⁻—OR8-NMe₃⁺-2, respectively. PPE-SO₃⁻—OR8-NMe₃⁺-1 and PPE-SO₃⁻—OR8-NMe₃⁺-2 are modified versions of a type I polyampholyte where the anionic/cationic groups are not in stoichiometric balance. These polymers are soluble in polar organic solvents and water and exhibit properties typical of polyelectrolytes of the dominant charge type.

Exemplary synthesis schemes for PPE-SO₃⁻—OR8-NMe₃⁺-1 and PPE-SO₃⁻—OR8-NMe₃⁺-2 are shown in FIG. 7. Briefly, 3,3′-(2,5-diiodo-1,4-phenylene)bis(oxy)dipropane-1-sulfonate (compound 9) was synthesized according to the literature procedure. See. e.g., Tan et al., Chem. Commun 2002, 446. 3,3′-[(2,5-Diiodo-1,4-phenylene)bis(oxy)]bis-[N,N,N-trimethylpropan-1-aminium] (compound 6) and 1,4-Diethynyl-2,5-bis[2-(2-methoxyethoxy)ethoxy] aromatic (compound 13) were synthesized according to the procedures described in for example, Ji, E.; Ph.D. Dissertation, University of Florida: 2009.

For synthesis of PPE-SO₃⁻—OR8-NMe₃⁺-1, a solution of compound 6 (22 mg, 0.03 mmol), compound 9 (46 mg, 0.07 mmol,) and compound 13 (36 mg, 0 1 mmol) in 15 mL of DMF/water/triethylamine (v/v/v=3/2/1) were placed in a Schlenk flask and degassed with argon for 30 minutes. CuI (2 mg, 0.01 mmol) and Pd(PPh₃)₄ (7 mg, 0.006 mmol) were added to the mixture solution containing compounds 6 and 9. The reaction mixture was stirred at 60 ° C. for 26 hours. The resultant solution was added to 200 mL of acetone to form a precipitate. The collected precipitate was dissolved in an aqueous solution containing NaCN (8 mg), filtered using a 25 μm glass filter and followed by dialysis against deionized water using 6-8 kD MWCO cellulose membrane for 2 days. The polymer solution was lyophilized to yield a yellow solid (50 mg, 57%). ¹H NMR (300 MHz, DMSO-d₆): δ 2.06 (br, 2.8H), 2.22 (br, 1.2H), 2.65 (br, 2.8H), 3.01 (br, 5.4 H), 3.25 (br, 6H), 3.43 (br, 4H), 3.66 (br, 5.2 H), 3.79 (b, 4H). ¹³C NMR (75 MHz, DMSO-d₆) spectrum was not obtained due to the limited solubility of the compound.

For synthesis of PPE-SO3⁻-OR8-NMe₃⁺-2, the procedure described above for PPE-SO3⁻-OR8-NMe₃⁺-1 was used with different amounts of compounds 6, 9, and 13. Specifically: compound 6 (51 mg, 0.07 mmol), compound 9 (20 mg, 0.03 mmol) and compound 13 (36 mg, 0.1 mmol). Yield: 12 mg, 13%. ¹H NMR (300 MHz, DMSO-d₆): δ 2.06 (br, 1.2 H), 2.24 (br, 2.8H), 2.66 (br, 1.2H), 3.07 (br, 12.6 H), 3.21 (br, 6H), 3.40 (br, 4H), 3.65 (br, 6.8H), 3.79 (br, 4H). ¹³C NMR (75 MHz, DMSO-d₆) spectrum was not obtained due to the limited solubility of the compound.

FIG. 8 shows the chemical structure of another exemplary embodiment of a polyampholyte structure of the present disclosure which is referred to herein as PPE-NMe3+-COO⁻. PPE-NMe3+-COO⁻ is a type II polyampholyte possessing quarternary ammonium and carboxylate groups. Due to the strongly hydrophilic character of the carboxylate and carboxylic acid groups, this polymer is able to remain soluble over a broad range of pH. Because of the weakly acidic nature of the carboxylate units, PPE-NMe3+-COO⁻ is a polyampholyte at high pH (i.e., above pH 7) and a polycation at low pH.

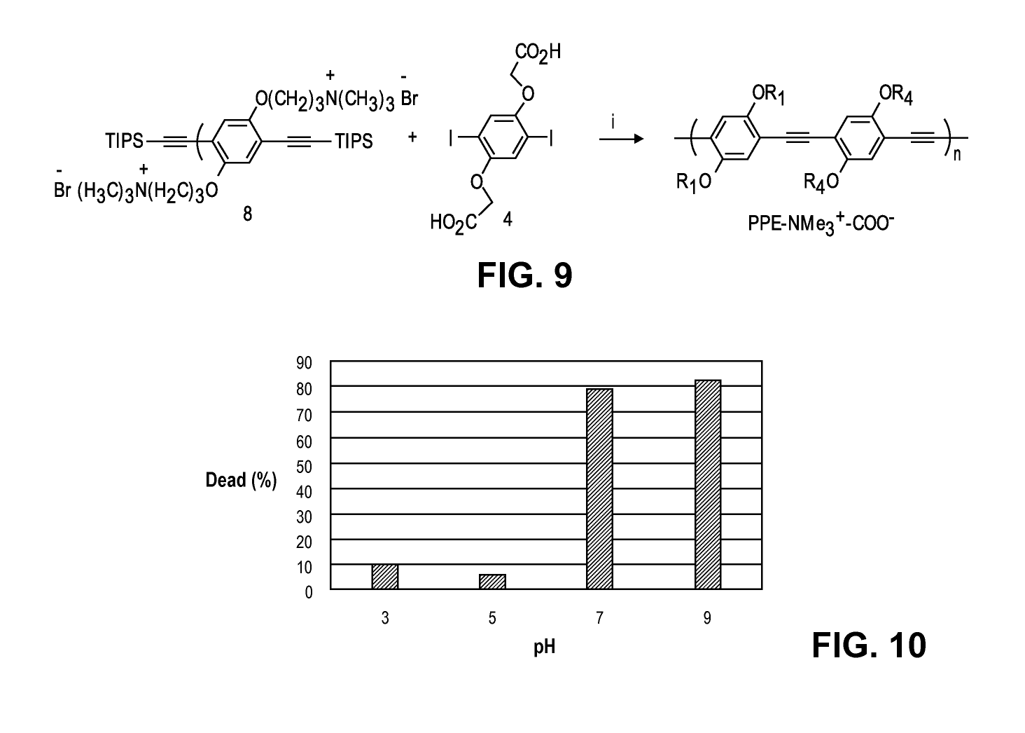

An exemplary synthesis scheme for PPE-NMe3+-COO⁻ is shown in FIG. 9. Briefly, 2,2′-(2,5-Diiodo-1,4-phenylene)bis(oxy)diacetic acid (compound 4) was synthesized according to the literature. See e.g., Zhao, X.; University of Florida Ph. D. Dissertation; Gainesville, Fla., 2007.

The solvent mixture (17 mL) of DMF/water/diisopropylamine (v/v/v/=9/6/2) was degassed with argon for 15 minutes and followed by the addition of compound 8 (79 mg, 0.095 mmol). After argon bubbling through the solution for 15 minutes, 1.0 M tetrabutylammonium fluoride solution in THF (0.95 mmol) was then added to the flask under argon and the mixture was stirred at room temperature for 30 minutes. CuI (2 mg, 0.011 mmol) and Pd(PPh₃)₄ (7 mg, 0.006 mmol) was added to the mixture solution. After 15 minutes of degassing, compound 4 was added and the reaction mixture was stirred under argon at 60° C. for 24 hours. The reaction mixture was poured into 200 mL of acetone. The precipitate was dissolved in small amount of Millipore water and treated with NaCN (8 mg), filtered using 25 μm glass filter and followed by dialysis against deionized water using 6-8 kD MWCO cellulose membrane for 2 days. The polymer solution was lyophilized to yield a yellow solid (10 mg, 15%). ¹H NMR (300 MHz, CD₃OD/D₂O) δ 2.23 (br, 4H), 3.10 (br, 18 H), 3.59 (br, 4H), 4.23 (br, 4H), 4.62 (br, 4H), 6.82 (br, 4H).¹³C NMR (75 MHz, CD₃OD) spectra were not obtained due to the limited solubility of the compound.

The solution properties of NMe₃⁺-COO⁻ which is a type II polyampholyte featuring quarternary ammonium and carboxylate groups were studied and are described in the Examples section below. In general, the optical properties of the conjugated backbone are sensitive to the environment and therefore we observe interesting changes in the absorption and fluorescence spectroscopy that are induced by changes in pH. As stated above, these changes are believed to arise due to pH induced crossover from polyampholyte at high pH to polycation at low pH. In particular, it is believed that the competition between homo- and heterosymplex formation¹⁶ is dependent on the pH of the polymer solution and this affects the optical properties of the polymer.

Each of the polyampholytes described herein has been tested for and has demonstrated significant dark and light-induced biocidal activity. An exemplary study is shown and described in Examples I and II, below. Accordingly, in yet another embodiment, the present disclosure provides novel biocides formed from or otherwise incorporating the polyampholytes described herein.

Furthermore, based on structural similarities with other compounds, future studies may show that some or all of the polyampholytes described herein are able to demonstrate significant antiviral activity.

Moreover, PPEs having structural similarities to the presently disclosed compounds have demonstrated significant antifungal activity (see e.g., applicant's co-pending PCT application serial no. PCT/US11/43922, which is hereby incorporated by reference). It may be reasonable to assume that the polyampholytes disclosed herein would also have significant antifungal activity due to the structural similarities.

Still further, oligo(phynylene ethynylenes) (OPEs) having structural similarities to the presently disclosed compounds have been shown to have significant activity against biofilms. See e.g., provisional patent application No. 61/559,232, filed Oct. 14, 2011, which is hereby incorporated by reference. Accordingly, it may be reasonable to assume that the compounds disclosed herein would also have significant activity against biofilms.

Accordingly, the polyampholytes disclosed herein may be able to interfere with the pathogenicity a wide variety of pathogens, by inactivating, killing, or otherwise harming them. Thus, the polyampholytes described herein are suitable for attachment to, incorporation in, or association with a wide variety of substances and materials in order to prevent, reduce, or eliminate pathogens and pathogen-related harm caused to or by the substances and materials.

For example, the polyampholytes disclosed herein are suitable for attachment to or formation of fibrous or other materials in order to produce textiles or other (soft or hard) surfaces having antimicrobial, antiviral, antifungal, and/or antibiofilm properties. Thus, according to various embodiments, it may be desirable to have one or more of the polyampholytes disclosed herein functionally and robustly attached to a surface, for example via covalent linkages so that it can interfere with the pathogenicity of any pathogen the polyampholytes comes into contact with. According to some embodiments, attachment of the polyampholyte via chemisorption and physisorption may also be used.

In chemisorptions, a textile substrate is chemically activated with a primer or initiator and then reacted with a polymer or prepolymer to graft the conjugated polyelectrolyte to the surface in a step growth polymerization process. Alternate reaction schemes may employ a living polymerization mechanism utilizing molecule by molecule propagation starting from a single molecule initiator.

In physisorption, the textile and conjugated polyeletrolyte are mixed under appropriate conditions such that the positively charged polymer attaches to the negatively charged textile surface. Typically the polyampholyte is dissolved in a solvent (e.g., water or methanol) and the fabric is “dyed” with the solution.

Alternatively, according to still an embodiment, an initial organosilane attachment may be used as a synthetic approach to accomplish surface grafting. See, e.g., Ogawa, K.; Chemburu, S.; Lopez, G. P.; Whitten, D. G.; Schanze, K. S. “Conjugated Polyelectrolyte-Grafted Silica Microspheres” Langmuir, 2007, 23, 4541-4548, which is hereby incorporated by reference. For example, by putting an organic iodine on the substrate we have grafted polyampholytes on nano- and micro-particles and planar surfaces. This silane approach may also be used to graft polyampholytes onto fabrics. Furthermore, this approach can be easily extended to provide more robust linkages than silanes, using modified chemistries for attaching polyampholytes to surfaces including ester, ether and amide linkages as needed.

Accordingly, the polyampholytes described herein may be incorporated into or onto hard or soft surfaces using the techniques described above or, alternatively, by other known casting, dipping, electrospinning or coating techniques.

Furthermore, the polyampholytes may themselves be formed into fibers, for example via electrospinning. A novel method for electrospinning OPEs, PPEs and polyampholytes is disclosed, for example, in U.S. Provisonal Patent Application No. 61/528,603, filed Aug. 29, 2011. Briefly, the conjugated electropolymer is electrospun in the presence of a sacrificial polymer carrier to produce fibers that form a continuous sheet of non-woven material.

However, it is noted that the photophysical properties of polyampholytes are dependent on planarity which can be affected by self-assembly onto a substrate or placement in a poor solvent. Accordingly, these factors should be considered and taken into account when selecting a particular attachment or incorporation method.

It will be appreciated that any suitable fabric or material, including natural and/or synthetic fibers and materials may be used as an attachment surface for the polyampholytes described herein. According to some embodiments, suitable fabrics may comprise or consist of natural fibers such as cotton, silk and/or wool, or suitable blends thereof. Blended fabrics may include only natural fibers, only synthetic fibers, or both natural and synthetic fibers. In some cases, the antimicrobial polymers described herein may be incorporated into electrospun fibers for woven fabrics including, but not limited to filters. Other suitable textiles may include, but are not necessarily limited to rayon, nylon, or blends of cotton, silk, wool or other natural fabrics or fibers with synthetic fabrics or fibers of rayon or nylon.

Potential uses of fibers may include prophylaxes for potentially contaminated surfaces including mattresses and bed linens, countertop coverings, tablecloths, curtains and various swabs, bandages, sterile mats and liners for use both inside and outside a sterile/clinical environment or in food-preparation areas. Their uses may be directed against known contamination, as in a wound infection, or applied as a deterrent to propagation of pathogenic agents in such applications as coverings for common fomites. Treatments of the compounds onto various cellulosic components would also enable their use as filter elements for water purification.

Different blends to specifically release or retain killed bacteria could be developed based on combination of polymers with the desired retention properties. This could be effected either by use of varied polymer proportions in a single layer coating or by building multiple layers with the required external affinities.

According to some embodiments, the polyampholytes described herein may be incorporated into materials having commercial, industrial and/or household applications. Alternatively, the polyampholytes described herein may be used as or incorporated into antimicrobial, antivirial or antifungal coatings for such materials. For the purposes of this application, it should be noted that the term “material” incorporates both “soft” and “hard” substances including organic and inorganic matter such as, but not limited to, natural and man-made fabrics, plant-based materials, metals, polymers, wood, stone, plastic, and the like.

Examples of suitable medical applications for the polyampholytes described herein include bedsheets, hospital garments, curtains, floor and wall materials, air filtration systems, medical devices, bandages, surgical instruments, gloves, masks, lab coats, gauze orthopedic prostheses, bedding, bed frames, mattress covers, surgical furniture, dividers, curtains, carts for transport of medication, linens, dental trays, incise drapes, wound dressings, and implants.

Applications for the building industry include the coating or incorporation of polyampholytes in wall laminates, hand rails, pulls, trims, door handles, slings, hoists, window blinds, paints, sealants, polishes, and plastics.

Other applications include coatings for keyboards, gaming devices, toys, (for example, but limited to, in a daycare environment), industrial, commercial and household kitchens, food preparation equipment and utensils or any other surface where a sterile environment is desirable.

According to various embodiments, the polyampholytes described herein may be incorporated into various aspects of filtrations devices. For example, the antimicrobial polymers may be incorporated into filter elements for air filtration systems such as those used in commercial or residential buildings, cars, buses, trains airplane cabins etc. Alternatively or additionally, the antimicrobial polymers may be incorporated into commercial or household water or other liquid filtration systems by application of coatings on equipment and incorporation into and/or coating on filters. Alternatively or additionally, the antimicrobial polymers described herein may be utilized in recoverable bacterial absorbents (by filtration or magnetic components) in the form of coated beads or other suitable substrates. Furthermore, they may be incorporated in separation membranes for bacterial exclusion, extraction, and/or immobilization. They may also be incorporated into or used as a coating for disposal bags for biological waste or other (potentially) contaminated materials.

Other applications include in-can or in-tank preservation of aqueous functional fluids. This may include incorporation of the presently described polyampholytes into polymer emulsions, paints and coatings, adhesives and sealants, mineral slurries, metal working fluids, cosmetics and personal care products and cooling and recreational water. (See, e.g., Bruns et al. “Directory of Microbiocides for the protection of materials: A Handbook Chapter 3 R&D in material protection: new biocides,” Wilfried Paulus, Ed.; Springer (2005).

Specific combinations and directed multilayer constructs may lend themselves to either single use or multiple uses, depending on the sequestration properties of that given combination. For example, coatings that have a high affinity for microbial binding may lend themselves more to single use applications (i.e. bandages or wipes) and those that would release microbial material, either upon washing or other decontamination could undergo multiple uses (i.e. bed linens, tablecloths).

According to various embodiments, the polyampholytes disclosed herein may be used to form or otherwise incorporated into gels or other materials. These gels or other materials may further include other biologically active materials. Much recent work has been devoted to the development of materials whose properties can be altered drastically by relatively small changes in properties such as temperature, pressure, solution or suspension properties (including but not limited to pH); these “stimuli responsive materials” (SRM) are often prepared as polymers or as surfaces prepared from components that can be covalently linked or self-assembled on surfaces. Smart polymers that have found use in biotechnology and medicine have been described by I Yu Galaev in Russian Chemical Reviews 64: 471-489 (1995); A. S. Hoffman in Clinical Chemistry 46:1478-1486 (2000) and H. G. Schild, Prog. Polym. Sci. 17, 163 (1992), incorporated herein by reference.

According to yet another embodiment, the present disclosure provides films and assemblies containing both SRM components and the polyampholytes described herein. In general, these assembles provide a novel functional material that can be switched between active and inactive forms wherein, in the active form, the material is able to capture a biological species of interest and, in the inactive form, the material is able to release the biological species. In some embodiments the material can be switched between active and inactive forms repeatedly, allowing for reuse of the same material. Films containing these two functional components can be readily prepared by covalent synthesis or by a self assembly process employing a mixture of individual SRM and polyampholytes thiols.

Accordingly, in one embodiment, the presently described structure can form a reusable biocidal material. Under low temperatures the antimicrobial activity of the polyampholyte is masked by the extended SRMs and therefore inactive. As stated above, elevation of the temperature above the LCST unsheathes the polyampholytes, which is then allowed to form a complex with, thereby trapping, the bacteria. The polyampholyte's biocidal activity is then exploited to inactivate, kill or destroy the trapped species, under either dark conditions or under uv light irradiation. Following destruction of the pathogen, the film will typically be contaminated with debris from the killed bacteria or cell. Returning the film to temperatures lower than the LCST results in expansion of the SRM, forcing the debris away from the polyampholyte. The result is a self-cleaning, reusable, biocidal film.

Examples of other practical uses for these mixed films include employing them as an active sensor which can be monitored by steady state fluorescence or by laser interferometery. The attachment of protein, cells or bacteria to the surface can be detected, for example, by the monitoring irradiation.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein. In addition, where features or aspects of the invention are described in terms of Markush groups, those skilled in the art will recognize that the invention is also thereby described in terms of any individual member or subgroup of members of the Markush group.

As used herein and in the appended claims, the singular forms “a,” “an,” and “the” include plural reference unless the context clearly dictates otherwise.

All patents and publications referenced below and/or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications. The following references are also incorporated by reference:
(1) McCormick, C. L. K., E. E. Polymeric Materials Encyclopedia; CRC Press: Boca Raton, 1996; Vol. 7, p 5462.
(2) Pinto, M. R.; Schanze, K. S. Synthesis-Stuttgart 2002, 1293.
(3) Reddinger, J. L.; Reynolds, J. R. Radical Polymerisation Polyeletrolytes 1999, 145, 57.
(4) Schluter, A. D. J. Polym. Sci., Part A: Polym. Chem. 2001, 39,1533.
(5) Shi, S. Q.; Wudl, F. Macromolecules 1990, 23, 2119.
(6) Wallow, T. I.; Novak, B. M. J. Am. Chem. Soc. 1991, 113, 7411.
(7) Liu, Y.; Ogawa, K.; Schanze, K. S. J. Photochem. Photobiol., C 2009, 10, 173.
(8) Chen, L. H.; McBranch, D. W.; Wang, H. L.; Helgeson, R.; Wudl, F.; Whitten, D. G. Proc. Natl. Acad. Sci. U.S.A. 1999, 96, 12287.
(9) Pinto, M. R.; Schanze, K. S. Proc. Natl. Acad. Sci. U.S.A. 2004, 101, 7505.
(10) Thomas, S. W.; Joly, G. D.; Swager, T. M. Chem. Rev. 2007, 107, 1339.
(11) Tan, C. Y.; Pinto, M. R.; Schanze, K. S. Chem. Commun. 2002, 446.
(12) Tan, C. Y.; Pinto, M. R.; Kose, M. E.; Ghiviriga, I.; Schanze, K. S. Adv. Mater. 2004, 16, 1208.
(13) Zhao, X. Y.; Pinto, M. R.; Hardison, L. M.; Mwaura, J.; Muller, J.; Jiang, H.; Witker, D.; Kleiman, V. D.; Reynolds, J. R.; Schanze, K. S. Macromolecules 2006, 39, 6355.
(14) Ibraeva, Z. E.; Hahn, M.; Jaeger, W.; Bimendina, L. A.; Kudaibergenov, S. E. Macromol. Chem. Phys. 2004, 205, 2464.
(15) Lowe, A. B.; McCormick, C. L. Chem. Rev. 2002, 102, 4177.
(16) Kotz, J.; Hahn, M.; Philipp, B.; Bekturov, E. A.; Kudaibergenov, S. E. Makromol. Chem. 1993, 194, 397.
(17) Xu, S. M.; Wu, R. L.; Huang, X. J.; Cao, L. Q.; Wang, J. D. J. Appl. Polym. Sci. 2006, 102, 986.
(18) Lee, W. F.; Tsai, C. C. Polymer 1995, 36, 357.
(19) Senthilikumar, S.; Nath, S.; Pal, H. Photochem. Photobiol. 2004, 80, 104.
(20) Wang, D. L.; Wang, J.; Moses, D.; Bazan, G. C.; Heeger, A. J. Langmuir 2001, 17, 1262.
(21) Tan, C. Y.; Alas, E.; Muller, J. G.; Pinto, M. R.; Kleiman, V. D.; Schanze, K. S. J. Am. Chem. Soc. 2004, 126, 13685.
(22) Jiang, H.; Zhao, X. Y.; Schanze, K. S. Langmuir 2007, 23, 9481.

### EXAMPLES

### Example I

### Biocidal Activity of PPE-NME₃⁺-COO⁻

The bactericidal activity of PPE-NMe3+-COO⁻ physisorbed particles was examined as a function of the pH of the polymer aqueous solution during physisorption. The results of exposing 5 um physisorbed particles to Staphylococcus aureus after 50 minutes exposure to visible light are shown in FIG. 10. Monolayer particles were built with PPE-NMe₃⁺-COO⁻ solution at pH 3.0, 5.0, 7.0 and 9.0. When pH 3 and 5 of PPE-NMe₃⁺-COO⁻ was deposited on negatively charged particle, bactericidal activity was not observed (control samples containing only bacteria showed about 10% dead bacteria without polymer treatment). When PPE-NMe3+-COO— at pH 7.0 and 9.0 was deposited on particles, the bactericidal activity of the particles increased dramatically to 80%. The plot was derived from flow cytometry analysis of the bacterial suspensions after live/dead staining.

### Example II

### Biocidal Activity of PPE-SO₃⁻—OR8-NMe₃⁺

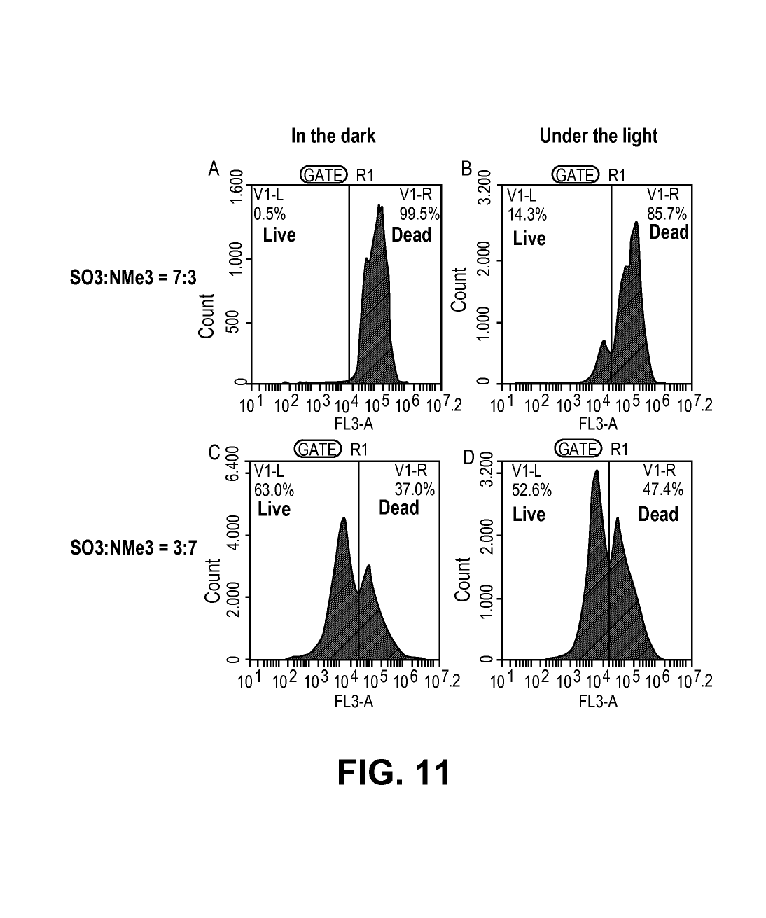

The bactericidal activity of PPE-SO₃—OR8-NMe₃⁺ solution against Bacillus atrophaeus was studied. FIG. 11 shows flow cytometry data of the bacterial suspensions after live/dead staining Activity in both the dark (FIG. 11, left) and under light (FIG. 11, right) was examined as a function of molar ratios of anionic (SO3−) to cationic (NMe3+) groups along the polymer backbone. While the polymer containing 7:3 (SO3:NMe3) ratio of pendant groups exhibits strong bactericidal activity both in the dark and under the light, the polymer with 3:7 (SO3:NMe3) ratio of pendant groups shows about 40% bacteria death.

### Example III

### Optical Characterization of PPE-NMe₃⁺—COO⁻

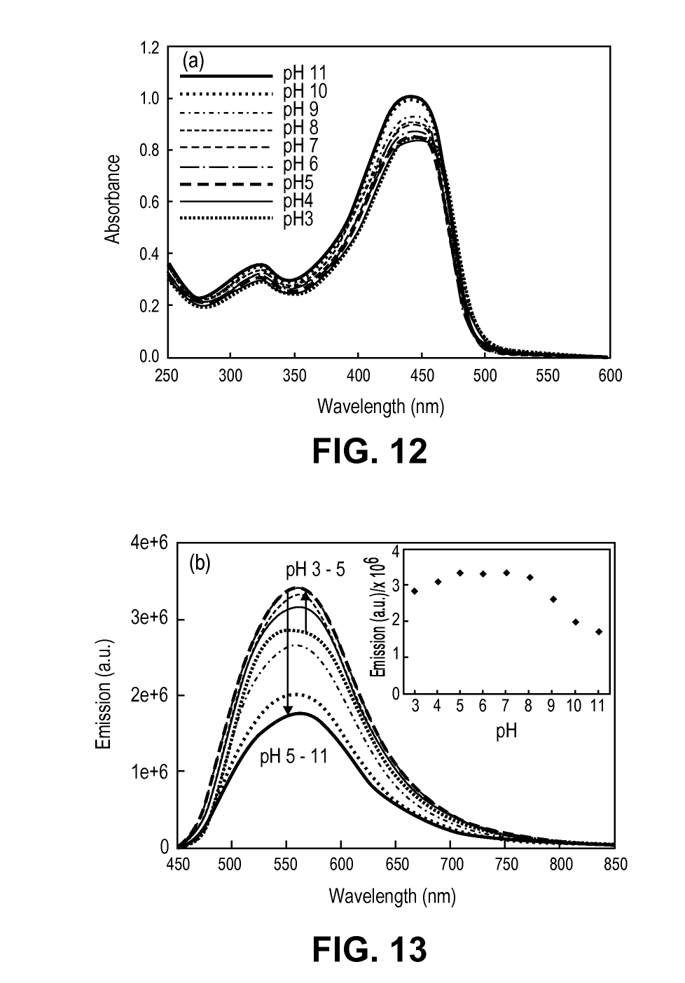

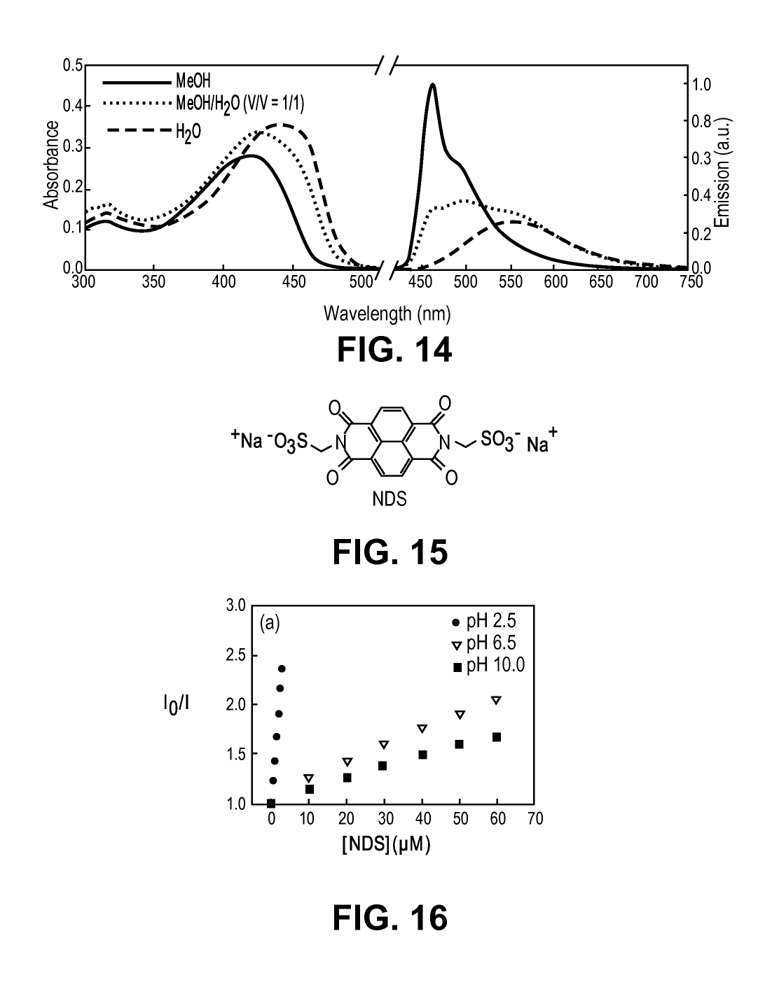

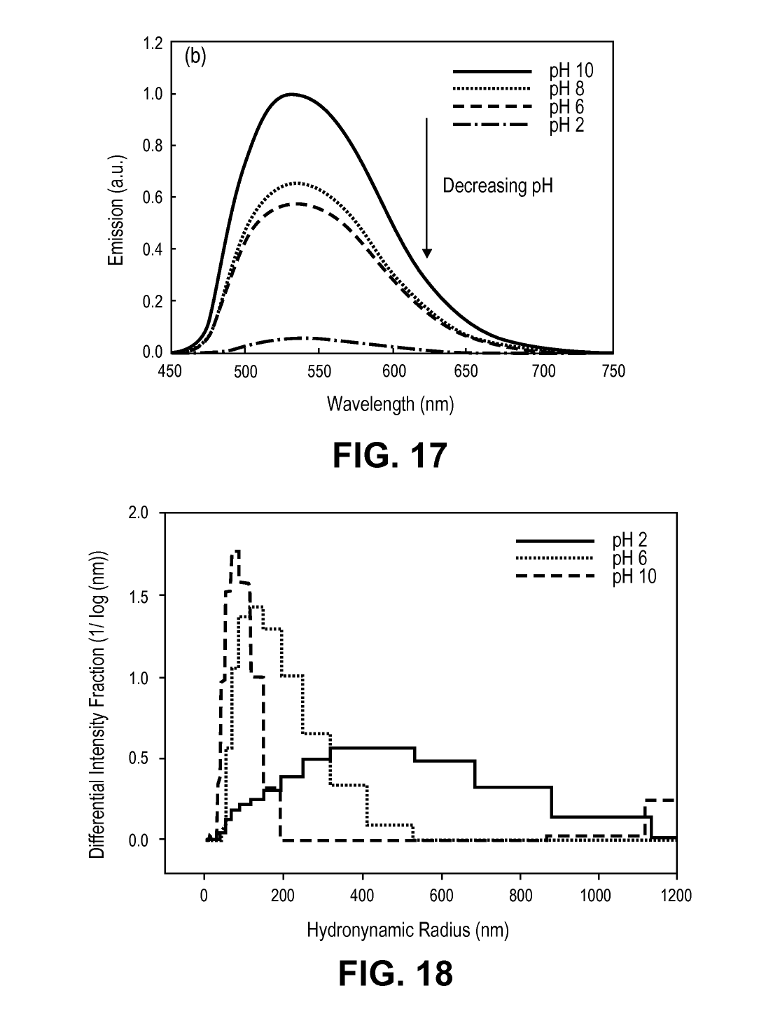

Optical studies of NMe₃⁺-COO⁻ were carried out in aqueous solution without added salt or buffer and pH was adjusted by addition of small amounts of acid (HCl) or base (NaOH). First, the absorption and fluorescence spectra of the polymer were recorded in solutions of differing pH and the results are show in FIGS. 12-14 as well as Table 1, below. (For reference, the spectral properties were also determined in methanol, which is believed to be a good solvent giving rise to molecularly dissolved chains, see supporting information.) The polymer absorbance is dominated by a broad and intense band with γ˜440 nm, which is typical of PPE-type conjugated polymers. See e.g., Pinto, M. R.; Schanze, K. S. Synthesis-Stuttgart 2002, 1293 and Tan, C. Y.; Pinto, M. R.; Schanze, K. S. Chem. Commun. 2002, 446. As shown in FIGS. 12-14, the oscillator strength of the primary absorption band increases slightly with increases pH of the solution (pH 3 to 11); however, the overall bandshape and wavelength maximum does not vary appreciably. PPE-NMe₃⁺-COO⁻ exhibits moderately efficient fluorescence which appears as a broad, structureless band with γ˜560 nm On the basis of previous studies of water-soluble PPE-type conjugated polymers and polyelectrolytes, we associate the broad fluorescence as a signal that PPE-NMe₃⁺—COO⁻ is aggregated throughout the range of pH investigated. (Note that the fluorescence of PPE-NMe₃⁺-COO⁻ is blue-shifted considerably in methanol solution, Table 1 and FIG. 14 which further supports the premise that the polymer is aggregated in water.)

Interestingly, the fluorescence quantum yield of PPE-NMe₃⁺-COO⁻ exhibits an unusual dependence on pH. In particular, starting at pH˜3, the quantum yield first increases with pH, leveling off at intermediate pH, and then decreases again at pH>8 (Table 1). These changes in the polymer fluorescence quantum yield are believed to be caused by subtle changes in the conjugated backbone structure induced by inter- and intrachain ionic and steric interactions induced by change in the state of ionization of the carboxylate units. At low pH (˜3), PPE-NMe₃⁺-COO⁻ exists as a polycation and the chains are aggregated as shown in previous studies of water soluble CPEs. See e.g., Pinto, M. R.; Schanze, K. S. Synthesis-Stuttgart 2002, 1293, Tan, C. Y.; Pinto, M. R.; Schanze, K. S. Chem. Commun. 2002, 446, and Tan, C. Y.; Pinto, M. R.; Kose, M. E.; Ghiviriga, I.; Schanze, K. S. Adv. Mater. 2004, 16, 1208.

This aggregation leads to reduced fluorescence intensity of the polymer via π-stacking between adjacent polymer chains. It is possible that the polymer aggregates “swell” with increasing pH (3-5) due to enhanced solubility of the chains induced by ionization of the carboxylate units, giving rise to slightly enhanced fluorescence. This swelling polymer aggregate is restricted to intermediate pH (5-8), because as pH continues to increase the density of negative carboxylate increases and leads to an increase in the attractive Coulombic interactions between the positively charged quaternary ammonium groups. See e.g., Xu, S. M.; Wu, R. L.; Huang, X. J.; Cao, L. Q.; Wang, J. D. J. Appl. Polym. Sci. 2006, 102, 986. This effect ultimately leads to a collapse of the aggregate structure which is signaled by a sharp decrease in fluorescence above pH 8. The Coulombic interactions force the polymer chains into a compact structure via polyanion-polycation complex (homosymplex) (See e.g., Kotz, J.; Hahn, M.; Philipp, B.; Bekturov, E. A.; Kudaibergenov, S. E. Makromol. Chem. 1993, 194, 397) or ionically crosslinked network. See e.g., McCormick, C. L. K., E. E. Polymeric Materials Encyclopedia; CRC Press: Boca Raton, 1996; Vol. 7, p 5462 and Lee, W. F.; Tsai, C. C. Polymer 1995, 36, 357.

TABLE 1
Photophysical and Fluorescence Quenching Data of PPE-NMe₃⁺—COO⁻

| | λₘₐₓ^{abs}/nm | λₘₐₓ^{fl}/nm | Φ_{fl} | K_{SV}/μM⁻¹ |
|---|---|---|---|---|
| MeOH^{a} | 420 | 463 | 0.10 ± 0.01^{b} | — |
| H₂O | 440 | 561 | 0.071 ± 0.007 (pH 3.0)^{b} | 0.455 (pH 2.5) |
| | | | 0.077 ± 0.007 (pH 7.6)^{b} | 0.019 (pH 6.5) |
| | | | 0.046 ± 0.004 (pH 10.3)^{b} | 0.012 (pH 10.0) |

As described above, CPEs have been of interest due to their amplified fluorescence quenching by low concentrations of oppositely charged quenchers. See e.g., Zhao, X. Y.; Pinto, M. R.; Hardison, L. M.; Mwaura, J.; Muller, J.; Jiang, H.; Witker, D.; Kleiman, V. D.; Reynolds, J. R.; Schanze, K. S. Macromolecules 2006, 39, 6355. The opposite charge leads to ion-paring between the quencher ion and the CPE chains, bringing the quencher into close proximity with the polymer and inducing highly efficient static quenching. Previous work has shown the amplified quenching effect is effective when the CPE chains are aggregated in water solution, and when the oppositely charged quencher is a polyvalent ion.20,21 The amplified fluorescence quenching efficiency depends on CPE structures and charge type; however, most cationic CPEs exhibit very efficient fluorescence quenching response by an anionic quencher, sodium 1,4,5,8-naphthalenediimide-N,N′-bis(methylsulfonate) (NDS) (FIG. 15). (See Zhao, cited above.)

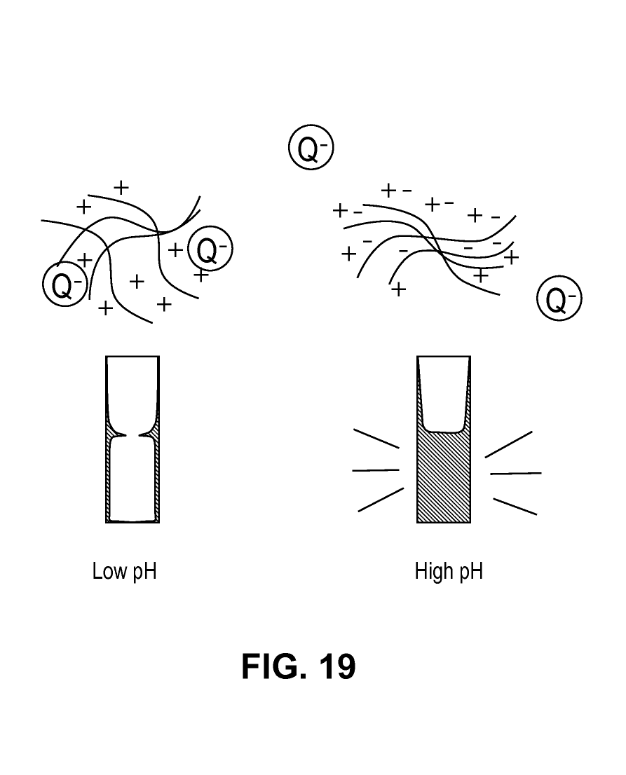

To investigate the relationship between solution pH and the fluorescence quenching efficiency of the polymer solution, quenching experiments were conducted with the polymer and NDS as a function of pH (FIG. 16). Stern-Volmer (SV) plots were constructed from fluorescence quenching studies of the polymer in three different pH conditions, and the quenching constants (Ksv) were calculated from the slope of the plots (Table 1). At low pH, most of the carboxyl groups are protonated, and thus the aggregated chains have a net overall positive charge due to the cationic tetraalkylammonium groups. Thus, we anticipate that the negatively charged NDS quencher ion will be ion-paired giving rise to amplified quenching. As expected, under these conditions (pH=2.5), the polymer's fluorescence is quenched relatively efficiently with a K_{SV}=4.55×105 M-1. This quenching efficiency is comparable to that observed in a previous investigation in which a series of cationic CPEs was quenched by NDS where values of K_{SV} ranged from 105-106 M-1.13 Interestingly, at pH 6.5 the SV quenching efficiency is dramatically lowered, with K_{SV}=1.9×104 M-1. This effect is clearly due to the fact that in the more basic solution the carboxyl units are deprotonated, bringing polyampholyte character to the chains. In this condition, the ion-pairing interaction between the tetralkylammonium groups and the NDS is suppressed lowering the overall quenching efficiency by nearly a factor of 50. The decreased interaction between the polyampholyte chains and the NDS is likely due to the fact that the overall charge on the aggregated chains is approximately zero, and also because of “internal” ion-paring interactions between the ammonium and carboxylate groups. There is a slight further decrease in quenching efficiency as the pH is increased to 10. This effect may arise because of the formation of a more compact aggregate structure induced by the homosymplex formation (as demonstrated in FIG. 19). Previous studies have demonstrated that aggregate structure (compact vs. swelled) influences the efficiency of quenching in CPE systems. See e.g., Jiang, H.; Zhao, X. Y.; Schanze, K. S. Langmuir 2007, 23, 9481. The overall effect of pH on the amplified quenching efficiency can be easily observed by the data in FIG. 18 which shows the change in fluorescence intensity as a function of pH for a fixed [NDS]=30 μM. Here it is seen that the intensity decreases with decreasing pH, with the most dramatic effect coming for pH<6, where the chains undergo a transition from polyampholyte to cationic polyelectrolyte nature.

1.-4. (canceled)

5. A polyampholyte having the structure: 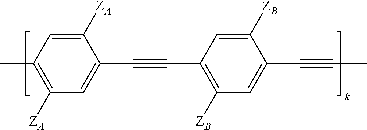
wherein:
k is selected from the numbers between 5 and 200;
Z_{A} is a negatively charged carbon chain; and
Z_{B} is a positively charged carbon chain.

6. The polyampholyte of claim 5 wherein Z_{A} is selected from O(CH₂)₃SO₃⁻ and OCH₂COO⁻.

7. The polyampholyte of claim 5 wherein Z_{B} is selected from O(CH₂)₃N(CH₃)₃⁺ and O(CH₂)₃(C₆H₁₂N₂)C₆H₁₃²⁺.

8. The polyampholyte of claim 6 wherein Z_{B} is selected from O(CH₂)₃N(CH₃)₃⁺ and O(CH₂)₃(C₆H₁₂N₂)C₆H₁₃²⁺.

9. The polyampholyte of claim 5 wherein the polyampholyte has biocidal properties.

10. A polyampholyte having the structure: 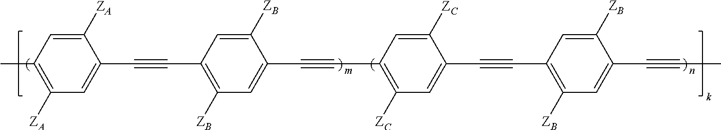
wherein:
k is selected from the numbers between 5 and 200;
Z_{A} is a negatively charged carbon chain
Z_{C} is a positively charged carbon chain; and
Z_{B} is O(C₂H₄O)₂CH₃;
wherein a ratio of m:n is selected from 3:7 and 7:3.

11. The polyampholyte of claim 10 wherein wherein Z_{A} is selected from O(CH₂)₃SO₃⁻ and OCH₂COO⁻.

12. The polyampholyte of claim 10 wherein Zc is selected from O(CH₂)₃N(CH₃)₃⁺ and O(CH₂)₃(C₆H₁₂N₂)C₆H₁₃²⁺.

13. The polyampholyte of claim 12 wherein Zc is selected from O(CH₂)₃N(CH₃)₃⁺ and O(CH₂)₃(C₆H₁₂N₂)C₆H₁₃²⁺.

14. (canceled)

15. (canceled)

16. The polyampholyte of claim 10 wherein the polyampholyte has biocidal properties.

17. A material incorporating a polyampholyte of claim 5 or 10.

18. A textile incorporating a polyampholyte of claim 5 or 10.

19. A particle incorporating a polyampholyte of claim 5 or 10.

20. A method for killing bacteria comprising exposing the bacteria to a polyampholyte of claim 5 or 10.

21. The method of claim 20 further comprising exposing the bacteria under dark conditions.

22. The method of claim 20 further comprising exposing the bacteria under light conditions.

23. The method of claim 20 wherein the polyampholyte is incorporated in a textile.

24. The method of claim 20 wherein the polyampholyte is in solution.

25. The method of claim 20 wherein the polyampholyte is incorporated in a particle.
